(19) United States
(12) Patent Application Publication
(10) Pub. No.: US 2021/0340742 A1
(43) Pub. Date: Nov. 4, 2021

(54) A BACKFLOW PREVENTER, A HOSE COUPLING OF A HYDRANT AND A HYDRANT

(71) Applicant: VONROLL INFRATEC (INVESTMENT) AG, Emmenbrucke (CH)

(72) Inventor: Christoph FLURY, Oensingen (CH)

(73) Assignee: VONROLL INFRATEC (INVESTMENT) AG, Emmenbrucke (CH)

(21) Appl. No.: 17/281,154

(22) PCT Filed: Sep. 27, 2019
(86) PCT No.: PCT/EP2019/076166

§ 371 Date: Mar. 29, 2021

(30) Foreign Application Priority Data
Oct. 2, 2018 (EP) 18198217.4

(51) Int. Cl. E03B 7/07; E03B 9/04; E03B 9/16; E03C 1/10; F16K 15/02; F16K 15/03

(52) U.S. Cl. CPC E03B 7/077; E03B 9/04; F16K 15/038; E03C 1/104; F16K 15/028; E03B 9/16

(57) ABSTRACT

A backflow preventer adapted for installation in an inner conduit of a hose coupling of a hydrant is disclosed. The backflow preventer contains a non-return device having a closing body, a seal seat, and a resetting device. The resetting device is adapted to resiliently pretension the closing body into sealing engagement against the seal seat.

The present invention relates to a backflow preventer, a hose coupling of a hydrant, and a hydrant.

Hydrants are connected to a water distribution system and represent a fitting for the withdrawal of water, thus enabling the fire department as well as public and private users to withdraw water from the water distribution system. The mains pressure in the water distribution system is typically about 6-9 bar. Hydrants comprise a riser pipe with an interior and an exterior, and the water distribution system is typically connected to the interior via a bottom-side inlet pipe. Water is drawn from the interior through side connections.

There is a problem in the prior art in that contaminated water can be forced or sucked from outside through the hose coupling into the interior of the hydrant and further into the water distribution system.

The publication DE 10 2006 028 854 discloses a backflow preventer with a cylindrical housing and a flange at a first end and an outlet side at a second end. The outlet side is provided with two bayonet claws for making a bayonet lock connection with, for example, an (external) standpipe. Inside the housing of the backflow preventer, a vertically movable valve closing element is mounted which, under the effect of outflowing water, lifts off a valve seat also integrated in the backflow preventer and, when the hydrant is closed, rests on the valve seat, thus closing the backflow preventer. The backflow preventer is placed on the outlet opening of the underground hydrant via its flange and screwed to it.

One problem with this prior art backflow preventer is that it must be laboriously coupled to the outlet of the underground hydrant via its flange, e.g., using a screw connection. However, these screws must be set and tightened in areas that are difficult to access. Also, loosening the screws is tedious and time-consuming due to poor accessibility, dirt deposits and especially corrosion.

Likewise, appropriate fluid-tight seals must be made between the backflow preventer and the outlet opening, e.g. by means of a rubber seal between the flange of the backflow preventer and the outlet opening of the hydrant. Another problem with known backflow preventers is that they form an excessively large extension at the hydrant outlet opening when installed, e.g. in terms of length, diameter or size in general. This causes space problems, for example. Because of the large extension, previously known backflow preventers are not used with above-ground hydrants. Another disadvantage of known backflow preventers is that they can be manipulated, damaged or removed without permission.

It is therefore the object of the present invention to provide a backflow preventer which does not have the above disadvantages.

This object is solved by a backflow preventer with the features given in claim 1. Advantageous embodiment variants as well as a hose coupling of a hydrant as well as a hydrant comprising such a hose coupling are indicated in further claims.

In accordance with the present invention, there is disclosed a backflow preventer adapted for installation in an inner conduit of a hose coupling of a hydrant. The backflow preventer includes a non-return device comprising a closing body, a seal seat and a resetting device, wherein the resetting device is adapted to resiliently pretension the closing body into sealing engagement against the seal seat.

Thus, a backflow preventer is created which can be inserted over a large part of its length into the outlet conduit of a hydrant via the hose coupling equipped with the backflow preventer. In this way, the backflow preventer extends essentially completely within the outlet conduit of the hydrant and does not protrude or protrudes only insignificantly from the outlet conduit of the hydrant. Thus, in an unforeseen and surprising way, the advantage is achieved that the hydrant equipped with the backflow preventer remains compact. Moreover, space problems are eliminated and the aesthetic appearance is not spoiled.

Likewise, unauthorized tampering and theft can be eliminated.

In an advantageous variant of the backflow preventer, the resetting device comprises at least one compression spring which is aligned in the axial direction of the inner conduit of the hose coupling, wherein the compression spring is designed to pretension the closing body in a sealing manner against the seal seat. The compression spring reliably pretensions the closing body against the seal seat so that the non-return device is reliably shut off in the depressurized state (no water draw). This prevents water, possibly contaminated extinguishing water, foreign substances or generally solid or liquid substances from entering the water distribution system via the riser pipe. As soon as the hydrant is opened, the water pressure applied to the closing body pushes it in the opening direction, thus enabling reliable water withdrawal.

In an advantageous variant of the backflow preventer, the closing body is provided at least in sections with a circumferential seal. The circumferential seal can be inserted in a groove formed in a surface section of the closing body.

In an advantageous variant of the backflow preventer, the closing body is axially guided by a plurality of webs provided circumferentially around the closing body. The axial guidance prevents the closing body from tilting.

Thus, the non-return device always opens and closes reliably.

In an advantageous variant of the backflow preventer, the webs are formed integrally with sections of the inner conduit of the hose coupling. For example, the webs can be formed by corresponding recesses on the inner circumference of the inner conduit, such that the webs remain behind. This allows the water to flow over the corresponding recesses. This method of manufacture has proven to be reliable and inexpensive.

In an advantageous variant of the backflow preventer, the closing body tapers essentially conically at least in the direction of the shut-off. In an example, the seal seat can be shaped to correspond to the conical shape of the closing body, at least in the area of the seal. Thus, the closing body or the seal coupled thereto comes into sealing engagement with an enlarged circumferential surface against the seal seat and can reliably seal the non-return device.

In an advantageous variant of the backflow preventer, the closing body comprises at least two partial bodies which can be coupled to one another, wherein at least one of the partial bodies being provided with a circumferential recess for receiving the seal. In this variant, the seal can be placed in an easily accessible manner on the circumferential recess of one of the partial bodies, for example by means of elastic deformation of the seal. Subsequently, the two partial bodies can be coupled to each other, for example by means of a screw connection. The circumferential seal is thus held positively between the two partial bodies.

In an alternative variant of the backflow preventer, the closing body is formed in one piece and provided with a circumferential recess for accommodating the seal. For example, the seal can be inserted into the recess by means of elastic deformation and remains reliably in place due to its clamping force.

In an advantageous variant, the backflow preventer comprises at least one shaft, which is coupled to the closing body at one end and is spring-elastically pretensioned against the hose coupling at the other end. This variant prevents possible tilting and thus allows reliable pretensioning of the closing body against the seal seat.

In an alternative variant of the non-return device, the closing body comprises at least one pivotably articulated sealing plate which is spring-elastically pretensioned by the resetting device in such a way that the sealing plate can be applied against the sealing surface in a sealing manner at least in sections. In this alternative variant, the non-return device is opened or closed by a sealing plate which is, for example, essentially circular in shape and is resiliently pretensioned against the sealing surface. The backflow preventer according to this variant is characterized by its reliability. At the same time, this backflow preventer is inexpensive to manufacture.

In an advantageous variant of the backflow preventer, the at least one sealing plate can be applied in a sealing manner against the sealing surface via a circumferential portion thereof. In a further advantageous variant of the backflow preventer, the closing body comprises two substantially semicircular sealing plates. In a further advantageous variant of the backflow preventer, the semicircular sealing plates are pivotably hinged such that a semicircular circumferential portion thereof can be applied in a sealing manner against the sealing surface in each case. Preferably, the resetting device comprises a torsion spring, which with at least one leg thereof resiliently pretensions the at least one sealing plate into sealing engagement against the seal seat. Preferably, the resetting device comprises a torsion spring with two legs, wherein the two legs resiliently pretension the two sealing plates into sealing engagement against the seal seat. In this way, the pretension can be applied particularly reliably to the two semicircular sealing plates.

In an advantageous variant, the backflow preventer further comprises a base part adapted to pivotally support the at least one sealing plate, wherein the base part can be accommodated in the inner conduit of the hose coupling. Preferably, the base part comprises a flange which can be coupled in a fluid-tight manner via its outer surface to the inner surface of the inner conduit of the hose coupling. The base part can thus be reliably sealed with respect to the inner conduit.

The invention further relates to a hose coupling for a hydrant, comprising a backflow preventer according to one of claims 1 to 17, designed to shut off a backflow of water via the hose coupling into the interior of the hydrant. The hose coupling according to the invention can be coupled to a water outlet or outlet conduit of the hydrant, e.g. by means of a threaded connection, and further allows coupling of a water hose by means of a corresponding coupling on the water hose in, for example, a claw coupling manner. The hose coupling according to the invention is characterized by its compactness, since it combines the hose coupling itself as well as the backflow preventer. Despite the presence of a backflow preventer, the hose coupling according to the invention does not protrude further from the water outlet of the hydrant than, for example, conventional hose couplings. Thus, this hose coupling can be reliably used with underground hydrants as well as with above-ground hydrants.

In a preferred variant, the hose coupling is designed for threaded coupling with a water outlet of the hydrant. In one example, the hose coupling can be easily and reliably screwed into a corresponding internal thread inside the water outlet of the hydrant via an external thread provided.

The invention further relates to a hydrant having a hose coupling according to claim 18 or 19, adapted to shut off a backflow of water via the hose coupling into the interior of the hydrant. The hydrant may be an underground hydrant or an above-ground hydrant. The hydrant according to the invention prevents a backflow of water via its hose coupling into the interior of the hydrant and thus into the connected water distribution system.

It is expressly pointed out that the above embodiment variants can be combined in any way. Only those combinations of embodiment variants are excluded which would lead to contradictions due to the combination.

In the following, the present invention is further explained with reference to exemplary embodiments shown in the drawings, wherein:

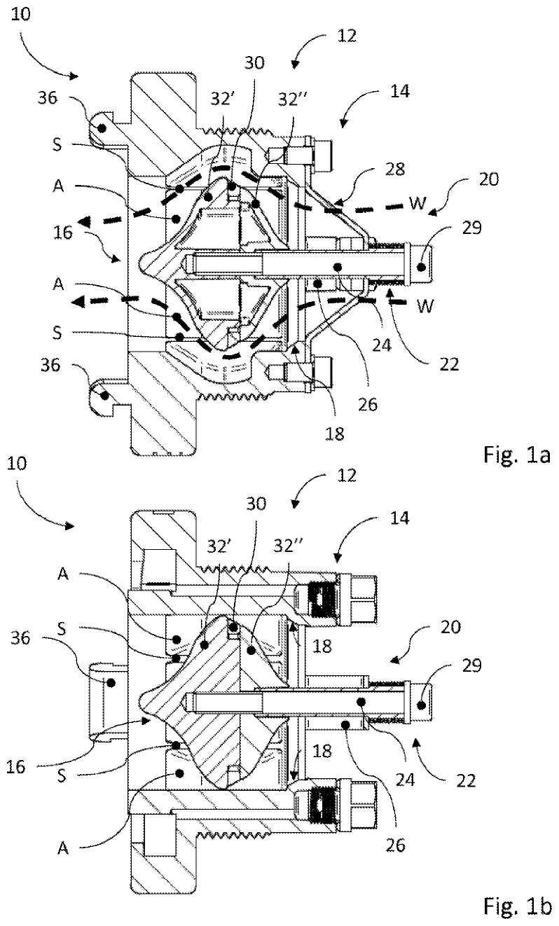

FIG. 1a shows a sectional view of a hose coupling with a backflow preventer in an extended state of the closing body thereof in a first view;

FIG. 1b shows a sectional view of the hose coupling shown in FIG. 1a with the backflow preventer in the extended state of the closing body in a second view;

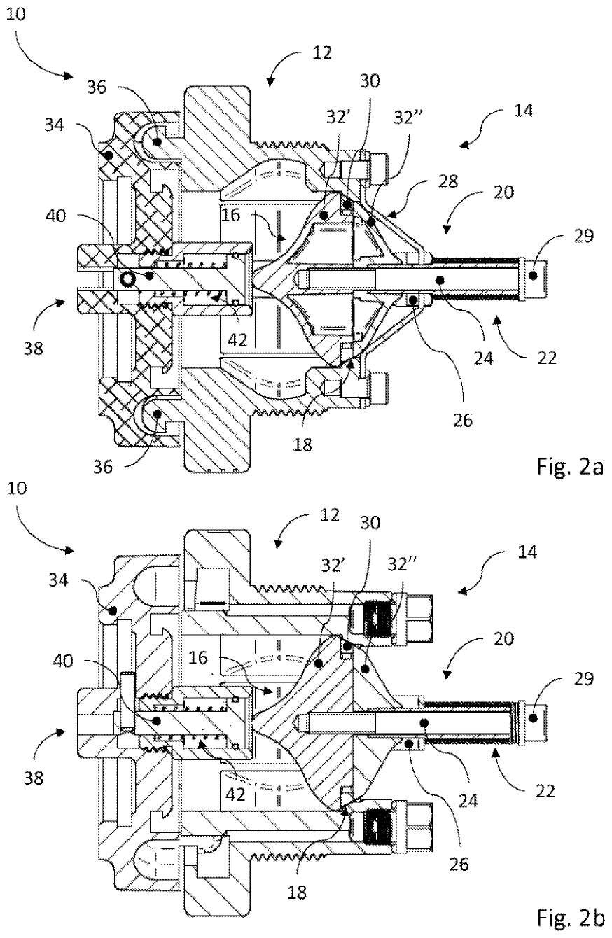

FIG. 2a shows a sectional view of the hose coupling shown in FIGS. 1a, 1b with the backflow preventer in a retracted state of the closing body in a first view;

FIG. 2b shows a sectional view of the hose coupling shown in FIG. 2a with the backflow preventer in the retracted state of the closing body in a second view;

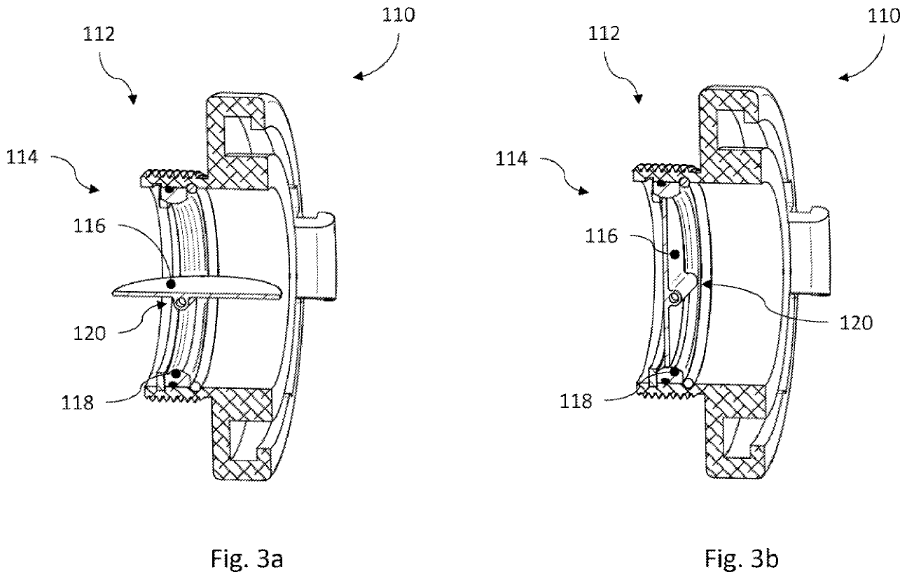

FIGS. 3a,b show a sectional view of a hose coupling with a backflow preventer in the open and closed state in a further embodiment; and

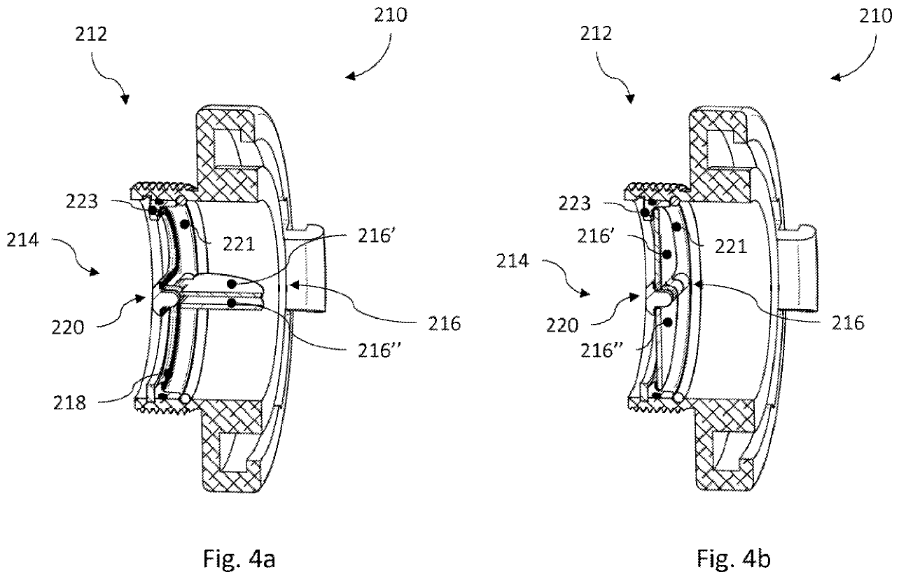

FIGS. 4a,b show a sectional view of a hose coupling with a backflow preventer in the open and closed state in a further embodiment.

FIGS. 1a-2b each show a hose coupling 10 in sectional view. The hose coupling 10 can be coupled to a water outlet of a hydrant (not shown) via a thread. The hose coupling 10 is equipped with a backflow preventer 12 inside or in an inner conduit thereof.

The backflow preventer 12 contains a non-return device 14 which allows water to flow out of the hydrant (in the figures, the direction of water flow is from right to left, see also arrows W in FIG. 1a), but blocks the backflow of water into the hydrant. Thus, water can still be drawn from the hydrant, but no water is admitted, or sucked, into the hydrant via the hose coupling 10. FIGS. 1a,b show the hose coupling 10 in a state with the closing body 16 extended, while FIGS. 2a,b show the hose coupling 10 in a state with the closing body 16 retracted.

FIGS. 1a and 1b differ in that the hose coupling 10 is shown in different views. Here, FIG. 1b shows the hose coupling 10 of FIG. 1a, but turned axially by an angle of 90°. The same relationship with regard to the views also applies between FIGS. 2a and 2b.

The non-return device 14 comprises a closing body 16, a seal seat 18 and a resetting device 20, which resiliently pretensions the closing body 16 into sealing engagement against the seal seat 18. In the embodiment shown in FIGS. 1a-2b, the resetting device 20 comprises a compression spring 22, which is aligned in the axial direction of the inner conduit. In this case, the compression spring 22 pretensions the closing body 16 in a sealing manner against the seal seat 18. For this purpose, the compression spring 22 is mounted on a shaft 24. One end of the shaft 24 is coupled to the closing body 16. The shaft 24 is mounted in an axial bearing 26 in such a way that the shaft 24 can be guided axially. The axial bearing 26 reliably prevents possible tilting of the shaft 24 during axial guidance thereof.

The compression spring 22, which is mounted on the shaft 24, has one end abutting a planar portion of a support 28, which in turn is rigidly coupled to the body of the hose coupling 10. The other end of the compression spring 22 abuts a portion of a cap 29, which is coupled to the distal end of the shaft 24. The compression spring 22 applies a compressive force between the support 28 and the cap 29 of the shaft 24, with the result that the closing body 16 is resiliently pretensioned against the body of the hose coupling 12.

In the depressurized state of the hydrant (no water draw), the shaft 24 is pushed away from the support 28 (and thus also from the body of the hose coupling 10) by the spring force of the compression spring 22, pressing the closing body 16 against the seal seat 18 (see FIGS. 2a,b). In this situation, the closing body 16 is retracted. The closing body 16 is pressed against the seal seat 18 by means of spring force of the compression spring 22, so that the resetting device 20 is reliably closed in this state. Thus, advantageously, no water can enter the hydrant from the outside.

In the event of a water draw (see FIGS. 1a,b), the water presses against a surface of the closing body 16 facing the inside of the hydrant. The force resulting from the water pressure acting on the closing body 16 pushes it into the open position against the spring force. In this situation, the closing body 16 is extended. Thus, water can be reliably drawn from the hydrant in this state.

As soon as the hydrant is closed again, the spring force prevails and forces the closing body 16 back into tight engagement against the seal seat 18. A backflow of e.g. extinguishing water into the hydrant is thus prevented.

For sealing purposes, the closing body 16 is provided with a circumferential seal 30 for reliable sealing with respect to the seal seat 18. The seal 30 may comprise a rubber material. In the embodiment shown, the closing body 16 comprises two partial bodies 32′,32″ which are coupled to each other. The outwardly facing partial body 32′ is provided with a circumferential recess into which the seal 30 can be placed or accommodated from the side. Once the two partial bodies 32′,32″ are coupled together, the seal 30 is positively retained between the two partial bodies 32′,32″. Although not shown, the recess may also be formed in the other partial body 32″ or the recess may be formed in both partial bodies 32′,32″. Furthermore, although not shown, the closing body may be integrally formed and provided with a circumferential recess for accommodating the seal.

The inner conduit of the hose coupling 12 is circumferentially provided with several webs S, against which the closing body 16 abuts over its circumference at least in sections. Thus, the closing body 16 can be reliably guided axially by means of the webs S. The webs S can be formed integrally with (material) sections of the inner conduit of the hose coupling 10, for example by corresponding recesses A being introduced into the material of the inner conduit. Those sections of the inner conduit which are not recessed thus form the corresponding webs S. Thus, a web S is present between adjacent recesses A in each case. In the extended state of the closing body 16, the water flows across the recesses A to the outlet side, as indicated in FIG. 1a by directional arrows W. The closing body 16 may be substantially conically tapered at least in the direction towards the shut-off, i.e. towards the interior of the hydrant. The closing body 16 may also be substantially conically tapered in the direction towards the outlet side of the hydrant. For example, water vortices in the outflowing water can thus be prevented. As a result, the flow of the water can be optimized, e.g. with regard to the optimum flow rate.

In the inoperative state of the hydrant, in the retracted state of the closing body 16 (see FIGS. 2a,b), the outlet side of the hose coupling 10 can be sealed or protected against the external environment by means of a fitted cover cap 34. In this regard, outwardly projecting claws 36 on the hose coupling 10 and corresponding recesses on the edge of the cover cap 34 can be engaged with each other in the manner of a claw connection. The cover cap 34 may include a pretensioning device 38, which includes a plunger 40 that presses against the distal end of the closing body 16 by means of a pretensioning compression spring 42. Thus, the closing body 16 is further reliably pressed into tight engagement against the seal seat 18.

FIGS. 3a,b and 4a,b each show a hose coupling 110;210 with a respective backflow preventer 112;212 set up in the open and closed states in further different embodiments. In both embodiments, the backflow preventer 112;212 comprises a non-return device 114;214 that shuts off the backflow of water into the hydrant while the hydrant is closed. Likewise, in both embodiments, the non-return device 114;214 comprises a closing body 116;216, a seal seat 118;218, and a resetting device 120;220 that resiliently pretensions the closing body 116;216 into sealing engagement against the seal seat 118;218.

FIGS. 3a,b each show a sectional view of a hose coupling 110 with a backflow preventer 112 in the open and closed states in a further embodiment. In the embodiment shown, the closing body 116 is designed as a pivotably articulated sealing plate 116 and the resetting device 120 is designed as a torsion spring 120 or torsion bar spring (shown schematically), which resiliently pretensions the sealing plate 116 relative to the body of the hose coupling 110 in such a way that the sealing plate 116 abuts against the sealing surface 118 in a sealing manner over its circumferential section at least in sections. As soon as the hydrant is opened, a force applied to the sealing plate 116 in the direction of flow is greater than the spring force of the torsion spring 120. As a result, the sealing plate 116 is lifted off the seal seat 118 and the water flows to the outlet side. As soon as the hydrant is closed again, the torque applied by the torsion spring 120 prevails and the sealing plate 116 is pressed against the seal seat 118 again. Thus, a backflow of water into the hydrant is prevented.

FIGS. 4a,b each show a sectional view of a hose coupling 210 with a backflow preventer 212 in an open and closed state in another embodiment. In the embodiment shown in the figures, the closing body is configured as sealing plates 216 comprising two substantially semi-circular sealing plates 216′,216″. The sealing plates 216′,216″ are pivotally articulated in such a way that a semicircular circumferential portion thereof is sealingly applied in each case against a seal seat 218. Furthermore, the resetting device is designed as one or more torsion springs 220 or torsion bar springs (shown schematically), each of which, for example by means of the two legs of the torsion spring, resiliently pretensions the sealing plates 216′,216″ into sealing engagement against the seal seat 218. The backflow preventer 212 further comprises a base part 221 on which the two sealing plates 216′,216″ are pivotally mounted. The base part 221 is insertable into the inner conduit of the hose coupling 210. For this purpose, the base part 221 comprises a flange 223 which is coupled in a fluid-tight manner via its outer surface to the inner surface of the inner conduit of the hose coupling 210, for example by means of an O-ring. The backflow preventer 212 can be removably fixed to the inner conduit of the hose coupling 210 by means of a snap ring or lock ring. Thus, the hose coupling 210 can be retrofitted with the backflow preventer 212. Maintenance work can also be simplified.

As soon as the hydrant is opened, a force applied to the sealing plates 216′,216″ in the direction of flow is greater than a torque applied by the torsion spring 220 or torsion bar spring, causing the sealing plates 216′,216″ to be lifted off the seal seat 218 (see FIG. 4a). Thus, water flows to the outlet side of the hydrant. Once the hydrant is closed again, the sealing plates 216′,216″ are pressed or forced back against the seal seat 218 by means of the torsion spring 220, thus preventing water from flowing back into the hydrant (see FIG. 4b).

1. A backflow preventer (12;112;212) adapted to be installed in an inner conduit of a hose coupling (10;110;210) of a hydrant, wherein the backflow preventer (12;112;212) contains a non-return device (14;114;214) comprising a closing body (16;116;216), a seal seat (18;118;218) and a resetting device (20;120;220), wherein the resetting device (20;120;220) is adapted to resiliently pretension the closing body (16;116;216) into sealing engagement against the seal seat (18;118;218).

2. The backflow preventer (12) according to claim 1, wherein the resetting device (20) comprises at least one compression spring (22) aligned in the axial direction of the inner conduit of the hose coupling (10), wherein the compression spring (22) is adapted to pretension the closing body (16) in a sealing manner against the seal seat (18).

3. The backflow preventer (12) according to claim 1, wherein the closing body (16) is provided at least in sections with a circumferential seal (30).

4. The backflow preventer (12) according to claim 1, wherein the closing body (16) is axially guided by a plurality of webs (S) provided circumferentially around the closing body (16).

5. The backflow preventer (12) according to claim 4, wherein the webs (S) are integrally formed with sections of the inner conduit of the hose coupling (10).

6. The backflow preventer (12) according to one of claim 1, wherein the closing body (16) is substantially tapered at least in the direction toward the shutoff.

7. The backflow preventer (12) according to claim 3, wherein the closing body (16) comprises at least two partial bodies (32′,32″) that can be coupled together, wherein at least one of the partial bodies is provided with a circumferential recess for receiving the seal (30).

8. The backflow preventer (12) according to claim 3, wherein the closing body (16) is formed integrally and is provided with a circumferentially extending recess for accommodating the seal (30).

9. The backflow preventer (12) according to claim 1, further comprising at least one shaft (24) coupled at one end to the closing body (16) and resiliently pretensioned at the other end relative to the hose coupling (10).

10. The backflow preventer (112;212) according to claim 1, wherein the closing body comprises at least one pivotally articulated sealing plate (116;216) which is resiliently pretensioned by the resetting device (120;220) in such a way that the sealing plate (116;216) can be applied at least in sections in a sealing manner against the sealing surface (118;218).

11. The backflow preventer (112;212) according to claim 10, wherein the at least one sealing plate (116;216) by means of a peripheral portion thereof can be applied in a sealing manner against the sealing surface (118;218).

12. The backflow preventer (212) according to claim 10, wherein the closing body (216) comprises two substantially semicircular sealing plates (216′,216″).

13. The backflow preventer (212) according to claim 12, wherein the semi-circular sealing plates (216′,216″) are pivotally articulated in such a way that a semi-circular circumferential portion thereof can be applied in a sealing manner against the sealing surface (218).

14. The backflow preventer (112;212) according to claim 10, wherein the resetting device comprises a torsion spring (120;220) which resiliently pretensions with at least one leg thereof the at least one sealing plate (116;216′,216″) into sealing engagement against the seal seat (118;218).

15. The backflow preventer (212) according to claim 12, wherein the resetting device comprises a torsion spring (220) having two legs, wherein the two legs resiliently pretension each of the two sealing plates (216′,216″) into sealing engagement against the seal seat (218).

16. The backflow preventer (212) according to claim 10, further comprising a base part (221) adapted to pivotally support the at least one sealing plate (216′,216″), wherein the base part (221) can be accommodated in the inner conduit of the hose coupling (210).

17. The backflow preventer (212) according to claim 16, wherein the base part (221) comprises a flange (223) which can be coupled in a fluid-tight manner via its outer surface to the inner surface of the inner conduit of the hose coupling (210).

18. A hose coupling (10;110;210) of a hydrant, comprising a backflow preventer (12;112;212) according to claim 1, adapted to shut off a backflow of water via the hose coupling (10;110;210) into the interior of the hydrant.

19. The hose coupling (10;110;210) according to claim 18, adapted for threaded coupling to a water outlet of the hydrant.

20. Hydrant comprising a hose coupling (10;110;210) according to claim 18, adapted to shut off a backflow of water via the hose coupling (10;110;210) into the interior of the hydrant.
